(19) United States
(12) Patent Application Publication
(10) Pub. No.: US 2026/0039763 A1
(43) Pub. Date: Feb. 5, 2026

(54) APPARATUS AND METHOD FOR CALCULATING CALIBRATION DATA FOR IMAGE SENSOR

(71) Applicant: SK hynix Inc., Icheon-si (KR)

(72) Inventors: Ji Ye HWANG, Icheon-si (KR); Eun Khwang LEE, Icheon-si (KR)

(21) Appl. No.: 19/224,444

(22) Filed: May 30, 2025

(30) Foreign Application Priority Data
Jul. 31, 2024 (KR) 10-2024-0102052

(51) Int. Cl. H04N 1/60; G06T 7/11; G06T 7/80; G06T 7/90; G06V 10/56; G06V 10/764

(52) U.S. Cl. CPC H04N 1/60; G06T 7/11; G06T 7/80; G06T 7/90; G06V 10/56; G06V 10/764; G06T 2207/10024

(57) ABSTRACT

An apparatus for calculating calibration data for an image sensor includes: a color image generator configured to receive a raw image from an image sensor and generate a plurality of color images by dividing a raw image by color; an area divider configured to divide each of the plurality of color images into pixel blocks, each pixel block having a preset size; a color ratio calculator configured to compare a reference color image with at least one non-reference color image and calculate color ratios for each pixel block of the at least one non-reference color image, the reference color image having a preset reference color and the at least one non-reference color image without having the preset reference color; and a conversion ratio calculator configured to calculate conversion ratios for each pixel block of the at least one non-reference color image using the color ratios for each pixel block.

### PRIORITY AND CROSS-REFERENCE TO RELATED APPLICATION

This patent document claims the priority and benefits of Korean patent application No. 10-2024-0102052, filed on Jul. 31, 2024, which is incorporated by reference in its entirety as part of the disclosure of this patent document.

### TECHNICAL FIELD

The technology and implementations disclosed in this patent document generally relate to an apparatus and method for calculating calibration data to prevent image-quality deterioration that may occur in an image sensor.

### BACKGROUND

An image sensor is a device for capturing optical images by converting light into electrical signals using a photosensitive semiconductor material which reacts to light. With the recent development of automotive, medical, computer and communication industries, the demand for high-performance image sensors is increasing in various fields such as smartphones, digital cameras, camcorders, personal communication systems (PCSs), game consoles, IoT (Internet of Things), robots, surveillance cameras, medical micro cameras, etc.

Such an image sensor may have poor pixel sensitivity in an edge area of the sensor due to a physical configuration (e.g., a module lens). In this case, a greenish phenomenon may be encountered in an extremely low-illuminance environment.

Intensive research has been conducted to address the greenish phenomenon that may occur in an image sensor.

### SUMMARY

Various embodiments of the disclosed technology relate to an apparatus and method for calculating calibration data to prevent image-quality deterioration that may occur in an image sensor.

In accordance with an embodiment of the disclosed technology, an apparatus for calculating calibration data for an image sensor may include: a color image generator configured to receive a raw image from an image sensor and generate a plurality of color images by dividing a raw image by color; an area divider configured to receive the plurality of color images from the color image generator and divide each of the plurality of color images into pixel blocks, each pixel block having a preset size; a color ratio calculator configured to compare a reference color image among the plurality of color images with at least one non-reference color image and calculate color ratios for each pixel block of the at least one non-reference color image, the reference color image having a preset reference color and the at least one non-reference color image without having the preset reference color; and a conversion ratio calculator configured to calculate conversion ratios for each pixel block of the at least one non-reference color image using the color ratios for each pixel block.

In accordance with another embodiment of the disclosed technology, an apparatus for calculating calibration data for an image sensor may include: a color image generator configured to receive a raw image from an image sensor and generate a red color image and a green color image by dividing the raw image by color, wherein the raw image includes red color pixels, green color pixels, and blue color pixels that are arranged in a Bayer pattern; an area divider configured to divide each of the red color image and the green color image into units of blocks; a color ratio calculator configured to calculate color ratios for each block for the red color image by comparing color values of blocks of the red color image and the green color image that are located at same positions; and a conversion ratio calculator configured to calculate conversion ratios for each block of the red color image using the color ratios for each block.

In accordance with another embodiment of the disclosed technology, a method for calculating calibration data for an image sensor may include: receiving a raw image from an image sensor; generating a plurality of color images by dividing the raw image by color; dividing each of the plurality of color images into pixel blocks, each pixel block having a preset size; comparing a reference color image having a preset reference color among the color images with a non-reference color image without having the preset reference color, and calculating color ratios for each pixel block of the non-reference color image; and calculating conversion ratios for each pixel block of the non-reference color image using the color ratios for each pixel block.

It is to be understood that both the foregoing general description and the following detailed description of the disclosed technology are illustrative and explanatory and are intended to provide further explanation of the disclosure as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram schematically illustrating an example of a device for calculating calibration data for an image sensor based on some implementations of the disclosed technology.

FIG. 2 is a schematic diagram illustrating an example structure of a pixel array included in the image sensor of FIG. 1 based on some implementations of the disclosed technology.

FIG. 3 is a flowchart illustrating a method for calculating calibration data for the image sensor based on some implementations of the disclosed technology.

FIG. 4 is a schematic diagram illustrating an example state in which color images are created by classifying a raw image into per-color images based on some implementations of the disclosed technology.

FIG. 5 is a schematic diagram illustrating examples of color values (e.g., signal values) for each pixel block of the color images of FIG. 4 based on some implementations of the disclosed technology.

FIG. 6 is a schematic diagram illustrating a color ratio for each pixel block of a red color image from among the color images of FIG. 5 based on some implementations of the disclosed technology.

FIG. 7 is a schematic diagram illustrating a result of calculating a conversion ratio by converting color ratios of FIG. 6 based on some implementations of the disclosed technology.

FIG. 8 is a schematic diagram illustrating an example of the result of calibrating color values of a red color image based on the conversion ratios of FIG. 7 based on some implementations of the disclosed technology.

### DETAILED DESCRIPTION

This patent document provides implementations and examples of an apparatus and method for calculating calibration data to prevent image-quality deterioration that may occur in an image sensor that may be used to substantially address one or more technical or engineering issues and mitigate limitations or disadvantages encountered in some other image sensing devices. Some implementations of the disclosed technology suggest examples of an apparatus and method for calculating calibration data to prevent image-quality deterioration that may occur in an image sensor. The disclosed technology provides various implementations of the device and method for calculating calibration data required for the image sensor, which can correct defective pixels having poor sensitivity during signal processing, thereby improving the image quality of the image sensor.

Reference will now be made in detail to certain embodiments, examples of which are illustrated in the accompanying drawings. Wherever possible, the same reference numbers will be used throughout the drawings to refer to the same or similar parts. In the following description, a detailed description of related known configurations or functions incorporated herein will be omitted to avoid obscuring the subject matter.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

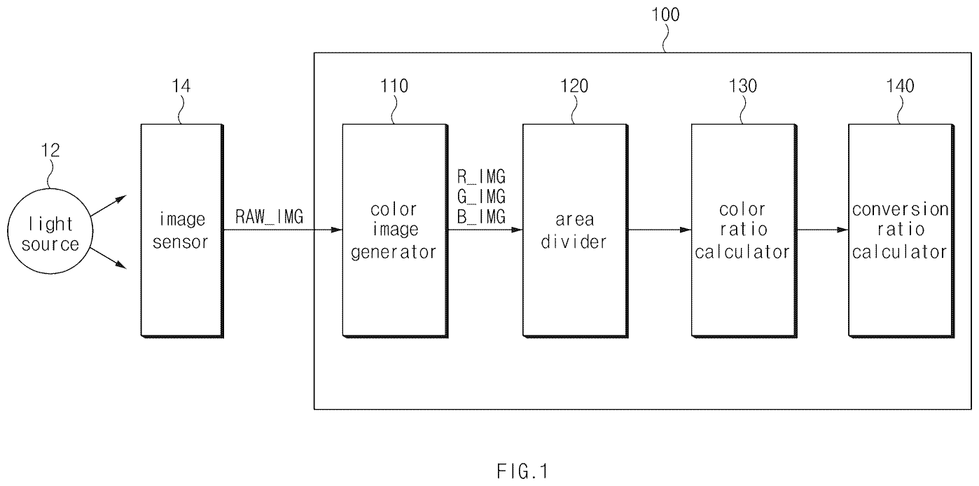

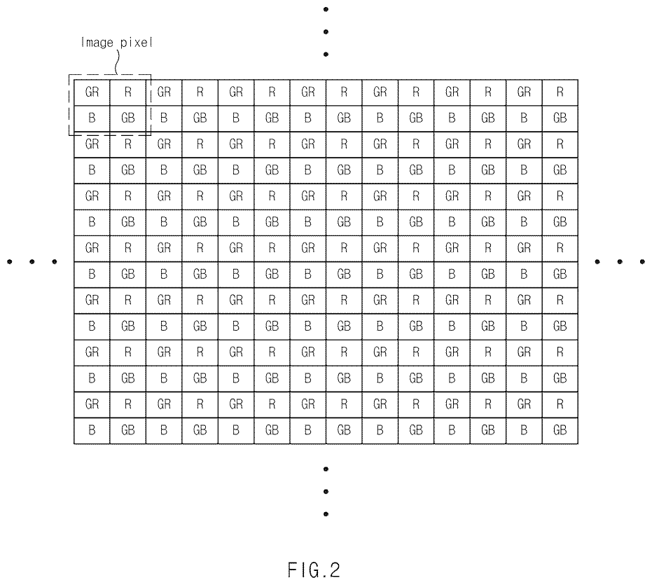

FIG. 1 is a block diagram schematically illustrating an example configuration of a device for calculating calibration data for an image sensor based on some implementations of the disclosed technology. FIG. 2 is a schematic diagram illustrating an example structure of a pixel array included in the image sensor of FIG. 1 based on some implementations of the disclosed technology.

Referring to FIGS. 1 and 2, a device (hereinafter referred to as a “calibration data calculation device”) 100 for calculating calibration data for the image sensor may include a color image generator 110, an area divider 120, a color ratio calculator 130, and a conversion ratio calculator 140.

The calibration data calculation device 100 may identify the greenish level of the image sensor during a wafer test process, and may calculate calibration data corresponding thereto.

The image sensor 14 may capture (photograph) a target object to form a raw image (RAW_IMG), and may transmit the raw image to the color image generator 110. The image sensor 14 may include a plurality of pixels that filters light corresponding to a specific color from among incident light and generates an electrical signal (pixel signal) corresponding to the filtered light. The plurality of pixels may include red (R) pixels that respectively generate pixel signals corresponding to red light, green (GR and GB) pixels that generate pixel signals corresponding to green light, and blue (B) pixels that respectively generate pixel signals corresponding to blue light. The R pixels, the GR pixels, the GB pixels, and the B pixels may be arranged in a Bayer pattern, as shown in FIG. 2. The raw image (RAW_IMG) captured and generated by the image sensor 14 may be an image in which signal values output from the pixels (R, GR GB, B) are arranged, as shown in FIG. 2.

During wafer testing, the image sensor 14 may generate a raw image (RAW_IMG) under a condition in which light from a light source 12 is uniformly applied to the image sensor 14, and may transmit the raw image (RAW_IMG) to the color image generator 110 of the calibration data calculation device 100. The raw image (RAW_IMG) is not generated only under specific conditions, but can also be generated under different condition in which illuminance (lux) and color temperatures of the light source 12 are varied from the specific conditions.

In the present embodiment, in the raw image (RAW_IMG), signal values corresponding to four pixels (R, GR, GB, B) adjacently arranged in a (2×2) matrix constituting one Bayer pattern are grouped and defined as one image pixel. In addition, in the raw image (RAW_IMG), signal values corresponding to the pixels (R, GR, GB, B) are defined as color pixels (R-color pixel, GR-color pixel, GB-color pixel, B-color pixel). In more detail, signal values corresponding to R pixels will hereinafter be defined as R-color pixels, signal values corresponding to GR pixels will hereinafter be defined as GR-color pixels, signal values corresponding to GB pixels will hereinafter be defined as GB-color pixels, and signal values corresponding to B pixels will hereinafter be defined as B-color pixels. For example, each image pixel may include one R-color pixel, one GR-color pixel, one GB-color pixel, and one B-color pixel.

The color image generator 110 may classify the color pixels (i.e., R-color pixels, GR-color pixels, GB-color pixels, and B-color pixels) of the raw image (RAW_IMG) received from the image sensor 14 into pixels for each color (R, G, B), and may generate color images (R_IMG, G_IMG, B_IMG) by rearranging the classified color pixels. For example, the color image generator 110 may rearrange the classified color pixels in the order of image pixels corresponding to the classified color pixels. At this time, since the GR-color pixel and the GB-color pixel correspond to the same green color, the color image generator 110 may calculate the average value of the GR-color pixel and the GB-color pixel for each image pixel for the green color, and may use the average value as the G-color pixel of the corresponding image pixel to generate the color image (G_IMG). For example, the color image generator 110 may classify the raw image (RAW_IMG) into images for each color, and may generate one color image (R_IMG) for the red color, one color image (G_IMG) for the green color, and one color image (B_IMG) for the blue color. The color image generator 110 may output the generated color images (R_IMG, G_IMG, B_IMG) to the area divider 120. The color images (R_IMG, G_IMG, B_IMG) may include color values for the image pixels.

The area divider 120 may be coupled to the color image generator 110 to receive the color images (R_IMG, G_IMG, B_IMG) from the color image generator 110. The area divider 120 may divide each of the color images (R_IMG, G_IMG, B_IMG) received from the color image generator 110 into pixel blocks having the same preset size. For example, the area divider 120 may divide each of the color images in units of single or multiple image pixels. For example, the area divider 120 may divide each of the color images into image pixels, or may divide each of the color images into a plurality of image pixels adjacently arranged in an (M×M) matrix (where M is an integer of 2 or greater). In the present embodiment, the area divider 120 may divide each of the color images into the respective image pixels. Thus, one pixel block may include one image pixel.

Information about the color images (R_IMG, G_IMG, B_IMG) and information about pixel blocks may be provided to the color ratio calculator 130.

The color ratio calculator 130 may compare color values (signal values) of pixel blocks located at the same positions from among the color images (R_IMG, G_IMG, B_IMG), and may calculate color ratios for each pixel block for some color images based on the result of comparison.

The color ratio calculator 130 may compare color images (non-reference color images) of other colors (non-reference colors) for each pixel block based on a color image (reference color image) of a preset color (reference color), may calculate ratios (color ratios) of color values of the non-reference color images based on the color value of the reference color image, and may allocate the calculated color ratios to the pixel blocks of the corresponding non-reference color images. For example, when the green color is used as a reference color, the color ratio calculator 130 may compare the reference color value (green color value) of the green color image (G_IMG) with the non-reference color value (e.g., red color value) of the red color image (R_IMG) for each pixel block, may calculate the ratio (i.e., RG ratio indicating the ratio of a red color value to a green color value) of the red color value to the green color value, and may allocate the calculated red color ratio (RG ratio) to the corresponding pixel block of the red color image (R_IMG). In the example, the color ratio calculator 130 may compare the reference color value of the green color image (G_IMG) with the non-reference color value (blue color value) of the blue color image (B_IMG) for each pixel block, and may calculate the ratio (i.e., BG ratio indicating the ratio of a blue color value to a green color value) of the blue color value to the green color value, and may allocate the calculated blue color ratio (BG ratio) to the corresponding pixel block of the blue color image (B_IMG). At this time, the red color ratio (RG ratio) may be a value obtained by dividing the red color value by the green color value, and the blue color ratio (BG ratio) may be a value obtained by dividing the blue color value by the green color value.

In the case where each pixel block is divided into multiple image pixels, the color ratio calculator 130 may first calculate an average value of the color values of the image pixels included in each pixel block, and may calculate the color ratio using the average value as the color value of the corresponding pixel block.

Information about the color ratio calculated by the color ratio calculator 130 may be transmitted to the conversion ratio calculator 140.

For each of non-reference color images other than the reference color image, the conversion ratio calculator 140 may calculate the conversion ratios. For example, in some implementations, the conversion ratio calculator 140 may calculate the conversion ratios of the non-reference color image based on the center of the non-reference color image. For example, each of color ratios allocated to each pixel block is proportionally converted by the conversion ratio calculator 140 based on the color ratio of the center pixel block located at the center of the corresponding non-reference color image. For example, for the red color image (R_IMG) having the center pixel block and non-center pixel blocks, the conversion ratio calculator 140 may calculate what the red color ratio (RG ratios) of the non-center pixel blocks is when the red color ratio (RG ratio) of the center pixel block is set to “1” to calculate the conversion ratio for each pixel block. In addition, for the blue color image (B_IMG) having the center pixel block and non-center pixel blocks, the conversion ratio calculator 140 may calculate what the blue color ratios (BG ratios) of the non-center pixel blocks is when the blue color ratio (BG ratio) of the center pixel block is set to “1” to obtain the conversion ratio for each pixel block. In the implementations, for each of the non-reference color images (e.g., the red color image and the blue color image when assuming that the green is the reference color), the conversion ratio calculator 140 may divide the color ratio of each pixel block by the color ratio of the center pixel block of the corresponding non-reference color image to obtain the conversion ratios for each pixel block.

The conversion ratios calculated by the conversion ratio calculator 140 may be stored in a memory device (e.g., a one-time programmable (OTP) memory), and may be used to calibrate data when processing image signals in image sensors that are actually manufactured.

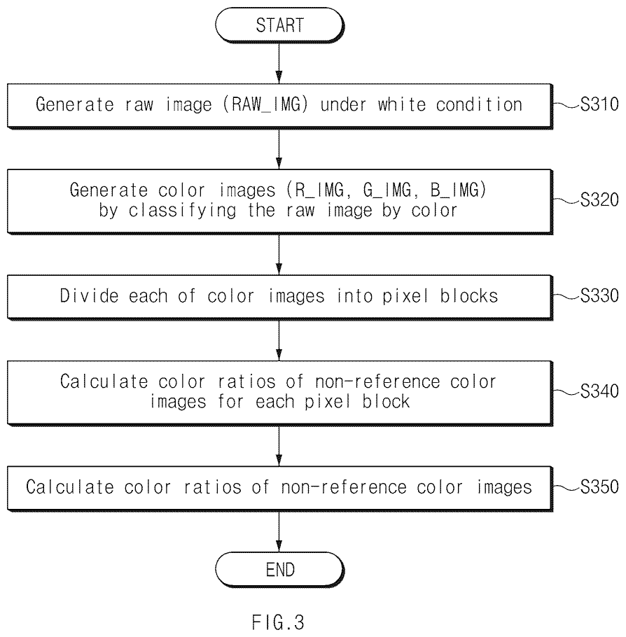

FIG. 3 is a flowchart illustrating a method for calculating calibration data required for the image sensor based on some implementations of the disclosed technology.

Referring to FIG. 3, during wafer testing, under a white condition in which light from the light source 12 is uniformly applied to the image sensor 14, the image sensor 14 may generate the raw image (RAW_IMG) (S310).

For example, under the condition where the illuminance (Lux) is adjusted so that illuminance of a green color signal of light incident upon a certain area (e.g., an area including pixels arranged in a (200×200) matrix) of the center region of the pixel array of the image sensor 14 reaches 200 LSB, the image sensor 14 may acquire a raw image. At this time, the image sensor 14 may be adjusted to have a high gain and a short integration time, so that the image sensor 14 may perform image capture in a low-illuminance environment.

The raw image (RAW_IMG) generated by the image sensor 14 may include a plurality of image pixels consecutively arranged in a first direction and a second direction perpendicular to the first direction. At this time, each image pixel may include four color pixels (R-color pixel, GR-color pixel, GB-color pixel, B-color pixel) arranged adjacently in a (2×2) matrix constituting one Bayer pattern.

The raw image (RAW_IMG) generated by the image sensor 14 may be transmitted to the color image generator 110 of the calibration data calculation device 100.

The color image generator 110 may classify the raw image (RAW_IMG) received from the image sensor 14 by color, and may generate three color images (R_IMG, G_IMG, B_IMG) (S320).

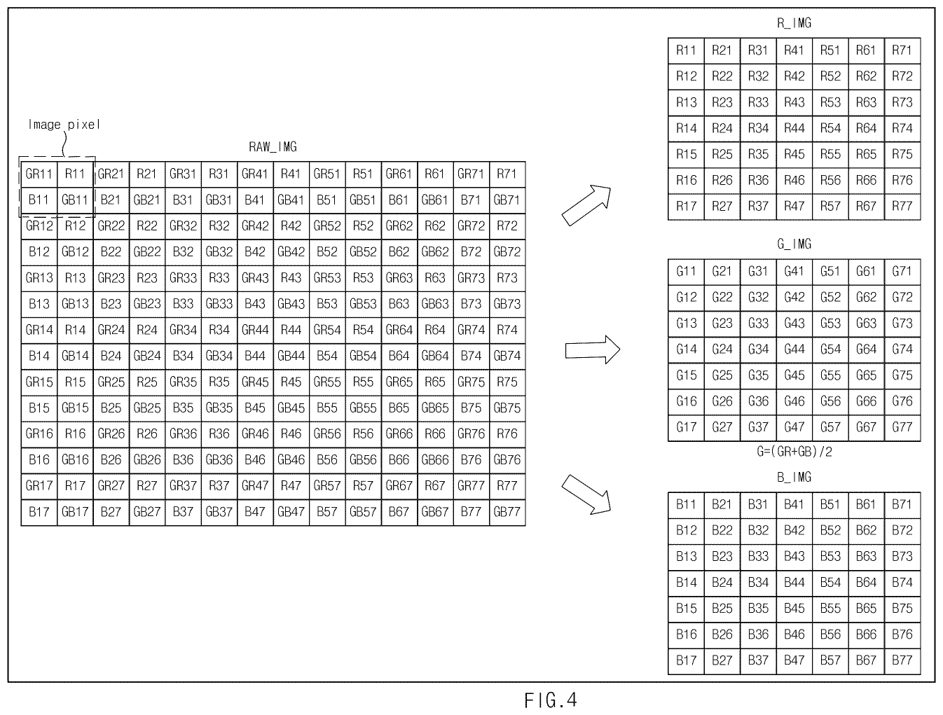

FIG. 4 is a schematic diagram illustrating an example state in which color images are created by classifying a raw image into per-color images based on some implementations of the disclosed technology.

For convenience of description, the present embodiment will disclose an example case in which the raw image (RAW_IMG) includes (14×14) color pixels arranged in a Bayer pattern, as shown in FIG. 4.

The color image generator 110 may select the R-color pixels (R11˜R77) from among the image pixels of the raw image (RAW_IMA), may rearrange the selected R-color pixels (R11˜R77) in the order of image pixels corresponding to the selected R-color pixels (R11˜R77), and may thus generate the color image (R_IMG) for the red color. For example, when rearranging the selected R-color pixels (R11˜R77), the R-color pixels, R11, R21, R31, R41, R51, R61, R71, are sequentially arranged at the first row of the color image (R_IMG) and the R-color pixels, R11, R12, R13, R14, R15, R16, R17, are sequentially arranged at the first column of the color image (R_IMG). The color image generator 110 may select the B-color pixels (B11˜B77) from among the image pixels of the raw image (RAW_IMA), may rearrange the selected B-color pixels (B11˜B77) in the order of the corresponding image pixels, and may thus generate the color image (B_IMG) for the blue color. In addition, the color image generator 110 may select the GR-color pixels (GR11˜GR77) and the GB-color pixels (GB11˜GB77) from the image pixels of the raw image (RAW_IMG), may calculate the average value “(GR+GB)/2” of the GR-color pixels and the GB-color pixels for each image pixel, may rearrange the calculated average values in the order of the corresponding image pixels, and may thus generate the color image (G_IMG) for the green color. In the example, the G-color pixel, G11, has the average value “GR11+GB11/2” of the GR-color pixel and the GB-color pixel for the corresponding image pixel including the GR11 and GB11.

When the raw image (RAW_IMG) includes (14×14) color pixels arranged in a Bayer pattern, each color image (R_IMG, G_IMG, B_IMG) may include (7×7) color pixels having the same color.

The color image generator 110 may output the generated color images (R_IMG, G_IMG, B_IMG) to the area divider 120.

The area divider 120 may divide each of the color images (R_IMG, G_IMG, B_IMG) into pixel blocks having the same preset size (S330).

For example, the area divider 120 may divide each of the color images in unit of image pixels, or may divide each of the color images in units of multiple image pixels adjacently arranged in an (M×M) matrix (where M is an integer of 2 or greater). In the present embodiment, an example case where the area divider 120 divides color images into the respective image pixels. Thus, in the below, the example case where one pixel block includes one image pixel will hereinafter be described as an example.

The color ratio calculator 130 may calculate the color ratio for each pixel block of color images by comparing the color values of pixel blocks located at the same positions in the color images (R_IMG, G_IMG, B_IMG) (S340).

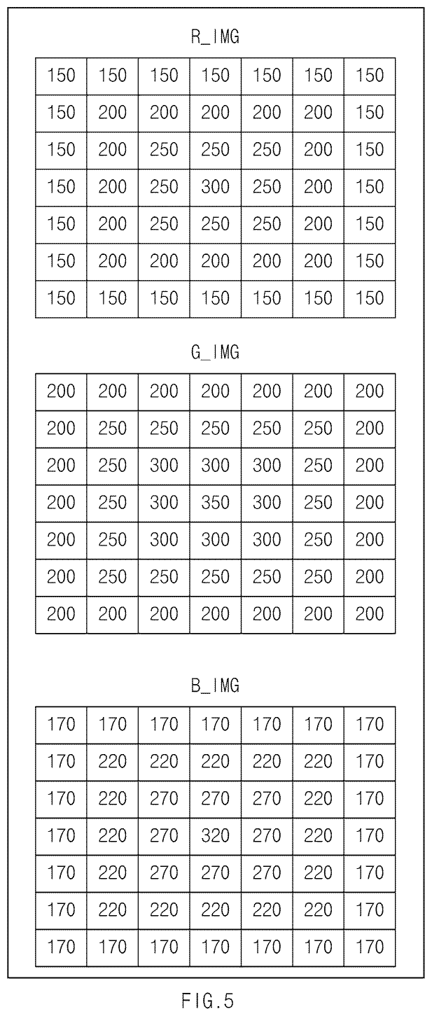

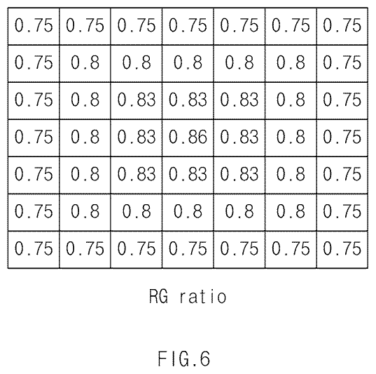

For example, the color ratio calculator 130 may compare color values of the reference color image with color values of the non-reference color images, and may calculate a color ratio indicating how much the color value of the non-reference color image for each pixel block differs from the color value of the reference color image for each pixel block. When the color ratio calculator 130 compares the color values between the reference color image and the non-reference color images, the color value at the Kth column and the Nth row of the reference color image is compared with the color value at the Kth column and the Nth row of the non-reference color image, where K and N are natural numbers. The operation of the color ratio calculator 130 will be further described with references to FIGS. 5 and 6.

FIG. 5 is a schematic diagram illustrating examples of color values (i.e., signal values) for each pixel block of the color images (R_IMG, G_IMG, B_IMG) of FIG. 4 based on some implementations of the disclosed technology. FIG. 6 is a schematic diagram illustrating a color ratio for each pixel block of a red color image from among the color images of FIG. 5 based on some implementations of the disclosed technology.

When the green color is set to the reference color, the color ratio calculator 130 may calculate the red color ratio (RG ratio) by dividing the color value of the red color image (R_IMG) for each pixel block by the color value of the green color image (G_IMG) for corresponding pixel block, and as shown in FIG. 6, the calculated red color ratio (RG ratio) may be allocated to the corresponding pixel block of the red color image (R_IMG). Similarly, the color ratio calculator 130 may calculate the blue color ratio (BG ratio) by dividing the color value of the blue color image (B_IMG) for each pixel block by the color value of the green color image (G_IMG) for corresponding pixel block, and may allocate the calculated blue color ratio (BG ratio) to the corresponding pixel block of the blue color image (B_IMG).

In operation S330, when each pixel block includes multiple image pixels, the color ratio calculator 130 may first calculate an average value of the color values of the image pixels included in each pixel block of the color images (R_IMG, G_IMG, B_IMG), and may calculate the color ratios (RG ratio, BG ratio) by using the calculated average value as the color value of the corresponding pixel block.

Subsequently, the conversion ratio calculator 140 may calculate the conversion ratio for each pixel block of the non-reference color images (R_IMG, B_IMG) (S350).

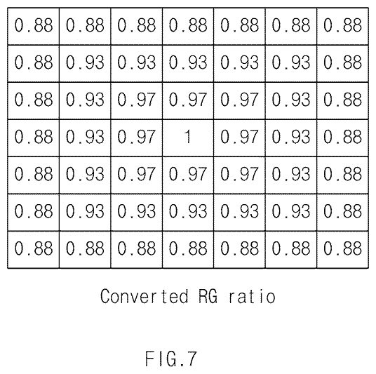

FIG. 7 is a schematic diagram illustrating the result of calculating the conversion ratio by converting the color ratios of FIG. 6 based on some implementations of the disclosed technology.

The conversion ratio calculator 140 may compare the color ratio of the center pixel block with the color ratio of each pixel block for each of the non-reference color images (R_IMG, B_IMG), and may calculate the conversion ratio of each pixel block proportionally. For example, as shown in FIG. 7, the conversion ratio calculator 140 may calculate what the red color ratios (RG ratios) of the non-center pixel blocks is when the red color ratio (RG ratio) of the center pixel block is set to “1” in the red color image (R_IMG) to calculate the conversion ratio for each pixel block. Similarly, the conversion ratio calculator 140 may calculate what the blue color ratios (BG ratios) of non-center pixel blocks when the blue color ratio (BG ratio) of the center pixel block is set to “1” in the blue color image (B_IMG) to calculate the conversion ratio for each pixel block.

The conversion ratios calculated by the conversion ratio calculator 140 may be stored in a memory device (e.g., OTP memory), and may be used to calibrate data when the image sensor actually processes image signals.

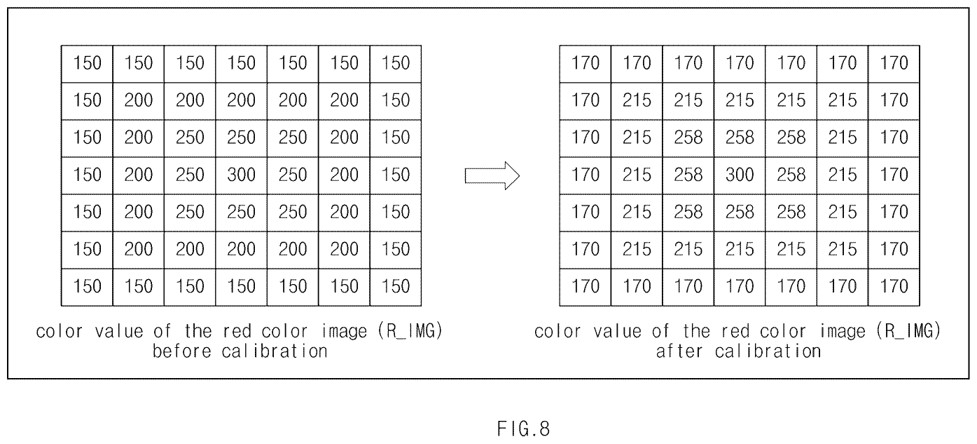

FIG. 8 is a schematic diagram illustrating an example of the result of calibrating the color values of the red color image based on the conversion ratios of FIG. 7 based on some implementations of the disclosed technology.

Referring to FIG. 8, when the conversion ratio of FIG. 7 is applied to the initial color value (i.e., a color value before calibration) of each pixel block of the red color image (R_IMG) (for example, when the initial color value of non-center pixel blocks of the red color image (R_IMG) is divided by the conversion ratio of FIG. 7), it can be seen that the color value in the center area is not changed and the changes of the color values gradually increase toward the edge area.

In the image sensor 14, due to the influence of the lens (e.g., a module lens), the magnitude of the edge region of the image sensor 14 may be relatively smaller than the magnitude of a signal generated in the center area of the image sensor 14. The greater the signal difference between the center area and the edge area, the higher the possibility that the greenish phenomenon occurs in the edge area under the low-illuminance environment.

Therefore, according to the present embodiment, occurrence of the greenish phenomenon can be minimized by gradually increasing the signal value in the direction from the center area to the edge area.

Although the above-described embodiment has disclosed the case in which calibration data (conversion ratios) is generated using the raw image obtained under a certain photographing (image capture) condition, different raw images can be obtained under various photographing conditions and the above operations S320 to S350 are performed for each raw image, so that calibration data for various photographing conditions can be generated. For example, in operation S310, the image sensor 14 may generate raw images under each condition while changing the illuminance (lux) and color temperature of the light source 12, and may transmit the raw images to the color image generator 110. Upon receiving the plurality of raw images, the color image generator 110 may generate the color images for each of the raw images. Thereafter, the above-described operations S330 to S350 are performed for each raw image, thereby generating calibration data (conversion ratios) for each photographing condition.

Calibration data for different photographing conditions may be stored in the OTP memory according to the photographing conditions, so that the stored calibration data can be used according to the corresponding photographing conditions. For example, the image sensor may divide the captured raw image into pixel blocks, may read calibration data (conversion ratios) corresponding to the photographing condition from the OTP memory, may divide the green color value and the red color value of the raw image for each pixel block by the corresponding conversion ratio to calibrate the green color value and the red color value, and may perform signal processing using the calibrated color values.

The above-described embodiment has disclosed, for convenience of description, only the example case in which calibration data for the red color and calibration data for the blue data are calculated based on the green color, but it is obvious that calibration data for other colors can be generated based on the red color or the blue color in the same way as described above.

In addition, although the above-described embodiment has disclosed the example case in which calibration data for the red color and calibration data for the blue color are calculated, the scope or spirit of the disclosed technology is not limited thereto. Since human eyes are more sensitive to red than blue, only the conversion ratios for the red color can be calculated and used. For example, in the above operation S320, the color image generator 110 may generate color images only for red and green colors. In the above operations S330 to S350, the color ratio per pixel block and the conversion ratio per pixel block can be calculated only for the red color image. At this time, the color image generator 110 may additionally generate a color image for the blue color if necessary.

As is apparent from the above description, the device and method for calculating calibration data required for the image sensor based on some implementations of the disclosed technology may correct defective pixels having poor sensitivity during signal processing, thereby improving the image quality of the image sensor.

The embodiments of the disclosed technology may provide a variety of effects capable of being directly or indirectly recognized through the above-mentioned patent document.

Although a number of illustrative embodiments have been described, it should be understood that various modifications or enhancements of the disclosed embodiments and other embodiments can be devised based on what is described and/or illustrated in this patent document.

What is claimed is:

1. An apparatus for calculating calibration data for an image sensor, comprising:
a color image generator configured to receive a raw image from an image sensor and generate a plurality of color images by dividing the raw image by color;
an area divider configured to receive the plurality of color images from the color image generator and divide each of the plurality of color images into pixel blocks, each pixel block having a preset size;
a color ratio calculator configured to compare a reference color image among the plurality of color images with at least one non-reference color image and calculate color ratios for each pixel block of the at least one non-reference color image, the reference color image having a preset reference color and the at least one non-reference color image without having the preset reference color; and
a conversion ratio calculator configured to calculate conversion ratios for each pixel block of the at least one non-reference color image using the color ratios for each pixel block.

2. The apparatus according to claim 1, wherein the color ratio calculator is configured to:
calculate color ratios for each pixel block by comparing color values of the pixel blocks located at same positions in the reference color image and the at least one non-reference color image.

3. The apparatus according to claim 2, wherein the color ratio calculator is configured to:
calculate the color ratios for each pixel block by dividing a color value of the at least one non-reference color image by a color value of the reference color image for pixel blocks located at the same positions in the reference color image and the at least one non-reference color image.

4. The apparatus according to claim 1, wherein the conversion ratio calculator is configured to:
proportionally convert each of the color ratios for each pixel block of the at least one non-reference color image based on a color ratio of a center pixel block located at a center of the non-reference color image to calculate the conversion ratios for each pixel block.

5. The apparatus according to claim 4, wherein the conversion ratio calculator is configured to:
calculate the conversion ratios for each pixel block by dividing the color ratios for each pixel block of the at least one non-reference color image by a color ratio of the center pixel block.

6. The apparatus according to claim 1, wherein:
the raw image includes a plurality of image pixels arranged in rows and columns, wherein each of the plurality of image pixels includes a red color pixel, a first green color pixel, a second green color pixel, and a blue color pixel arranged in a Bayer pattern; and
the color image generator is configured to classify the color pixels of the raw image by color, rearrange the classified color pixels in an order of image pixels corresponding to the classified color pixels, and generate a red color image, a green color image and a blue color image.

7. The apparatus according to claim 6, wherein the color image generator is configured to:
generate the green color image by using an average value of color values of the first and second green color pixels for each image pixel.

8. The apparatus according to claim 6, wherein the area divider is configured to:
classify the plurality of color images in units of one or multiple image pixels.

9. The apparatus according to claim 8, wherein the color ratio calculator is configured to:
calculate the color ratios for each pixel block for the red color image and the blue color image by using the green color image as the reference color image.

10. The apparatus according to claim 8, wherein the color ratio calculator is configured to:
when each of the plurality of color images is divided into the pixel blocks in units of multiple image pixels, calculate color ratios for each pixel block by comparing average values of the multiple image pixels.

11. An apparatus for calculating calibration data for an image sensor, comprising:
a color image generator configured to receive a raw image from an image sensor and generate a red color image and a green color image by dividing the raw image by color, wherein the raw image includes red color pixels, green color pixels, and blue color pixels that are arranged in a Bayer pattern;
an area divider configured to divide each of the red color image and the green color image into units of blocks;
a color ratio calculator configured to calculate color ratios for each block for the red color image by comparing color values of blocks of the red color image and the green color image that are located at same positions; and
a conversion ratio calculator configured to calculate conversion ratios for each block of the red color image using the color ratios for each block.

12. The apparatus according to claim 11, wherein the color ratio calculator is configured to:
for each of the blocks located at the same positions, divide a color value of the red color image by a color value of the green color image to calculate color ratios for each block.

13. The apparatus according to claim 12, wherein the conversion ratio calculator is configured to:
proportionally convert the color ratios for each block of the red color image based on a color ratio of a center block located at a center of the red color image to calculate the conversion ratios for each block.

14. The apparatus according to claim 13, wherein the conversion ratio calculator is configured to:
calculate the conversion ratios for each block by dividing the color ratios for each block of the red color image by a color ratio of the center block.

15. A method for calculating calibration data for an image sensor, comprising:
receiving a raw image from an image sensor;
generating a plurality of color images by dividing the raw image by color;
dividing each of the plurality of color images into pixel blocks, each pixel block having a preset size;
comparing a reference color image having a preset reference color among the color images with a non-reference color image without having the preset reference color, and calculating color ratios for each pixel block of the non-reference color image; and
calculating conversion ratios for each pixel block of the non-reference color image using the color ratios for each pixel block.

16. The method according to claim 15, wherein the calculating the color ratios includes:
calculating color ratios for each pixel block by comparing color values of the pixel blocks located at same positions in the reference color image and the non-reference color image.

17. The method according to claim 15, wherein the calculating the conversion ratios includes:
proportionally converting the color ratios for each pixel block of the non-reference color image based on a color ratio of a center pixel block located at a center of the non-reference color image to calculate the conversion ratios for each pixel block.

18. The method according to claim 15, wherein:
the raw image includes a plurality of image pixels arranged in rows and columns, wherein each of the plurality of image pixels includes a red color pixel, green color pixel, and a blue color pixel arranged in a Bayer pattern; and
the generating the plurality of color image includes:
classifying the color pixels of the raw image by color;
rearranging the classified color pixels in an order of image pixels corresponding to the classified color pixels; and
generating a green color image and a blue color image.

19. The method according to claim 18, wherein the calculating the color ratios includes:
calculating the color ratios for each pixel block for the red color image and the blue color image by using the green color image as the reference color image.

20. The method according to claim 18, wherein the dividing each of the plurality of color images includes:
classifying the plurality of color images either in units of one or multiple image pixels.
